(19) United States
(12) Patent Application Publication
(10) Pub. No.: US 2014/0327907 A1
(43) Pub. Date: Nov. 6, 2014

(54) COMPONENT QUANTITATIVE ANALYZING METHOD DEPENDING ON DEPTH OF CIGS FILM USING LASER INDUCED BREAKDOWN SPECTROSCOPY

(71) Applicant: GWANGJU INSTITUTE OF SCIENCE AND TECHNOLOGY, Gwangju (KR)

(72) Inventors: Sungho JEONG, Gwangju (KR); Chan Kyu KIM, Gwangju (KR); Seokhee LEE, Gwangju (KR); Jeong Hwan IN, Gwangju (KR); Hakjae LEE, Gwangju (KR)

(73) Assignee: GWANGJU INSTITUTE OF SCIENCE AND TECHNOLOGY, Gwangju (KR)

(21) Appl. No.: 14/143,911

(22) Filed: Dec. 30, 2013

(30) Foreign Application Priority Data
May 2, 2013 (KR) 10-2013-0049310

(51) Int. Cl. G01J 3/443

(52) U.S. Cl. CPC G01J 3/443
USPC 356/318

(57) ABSTRACT

Disclosed herein is a component quantitative analyzing method depending on a depth of a CIGS film, the method including: generating plasma by irradiating a laser beam on the CIGS film and obtaining spectra generated from the plasma, selecting spectral lines having similar characteristics among spectra of specific elements of the CIGS film, and measuring component composition using a value obtained by summing intensities of the selected spectral lines.

### CROSS REFERENCE TO RELATED APPLICATION

This application claims the benefit of Korean Patent Application No. 10-2013-0049310, filed on May 2, 2013, which is hereby incorporated by reference in its entirety into this application.

### BACKGROUND OF THE INVENTION

1. Technical Field

The present invention relates to a component quantitative analyzing method depending on a depth of a CIGS film using a laser induced breakdown spectroscopy.

2. Description of the Related Art

Plasma generated by laser irradiation emits light having a specific wavelength depending on the material on which the laser is irradiated. As a result, components of the material may be qualitatively or quantitatively analyzed by collecting the light. A laser induced breakdown spectroscopy (hereinafter, referred to as LIBS), which is one method of analyzing the components of the material using the collected light, is a spectroscopic analysis technology using plasma produced by generating breakdown, which is a kind of discharge phenomenon, using a high output laser, as an excitation source. A sample is vaporized in the plasma induced by the laser, such that atoms and ions may be present in an excited state. The atoms and ions in the excited state release energy after a predetermined lifespan and return back to a ground state. In this case, the atoms and ions emit light having a unique wavelength according to the kind of elements and the excited state. Therefore, when analyzing a spectrum of the emitted light, the components of the material may be qualitatively or quantitatively analyzed.

FIG. 1 is an illustration view showing an operation principle of an LIBS according to the related art.

Referring to FIG. 1, first, in the case in which an ablation (a phenomenon in which the material is removed while being melted and evaporated by the laser) is performed for a material having a very small quantity (several μg) by irradiating a pulse laser, as in Step 102, the ablated material absorbs laser energy to thereby cause ionization in a very short time (typically, in several nanoseconds), and to form high temperature plasma of about 15000K or more as in Step 104. When a laser pulse is stopped, the respective elements present in the plasma emit specific spectra corresponding thereto while the high temperature plasma is cooled. In this case, by collecting and analyzing the emitted spectra using a spectrometer as in Step 106, unique spectrum data of each element may be obtained as in Step 108 and component composition and quantity of substance contained in the material may be measured by analyzing the spectrum data.

The LIBS technology is different from other measuring technologies in that 1) an entire time spent on measuring is within 1 second, 2) a separate sampling and pre-conditioning process for the measurement is not required, 3) since only a very small quantity (several μg) of material is consumed for one measurement, an elementary composition of the material may be measured precisely to nm unit while the material is ablated in a depth direction, 4) a separate environment for the measurement is not required and the measurement may be performed under air atmosphere, 5) all elements except for an inert gas may be analyzed in ppm precision, and 6) an instrument may be configured at relatively low costs.

FIG. 2 is a chart comparing the LIBS with other analytical technologies.

Referring to FIG. 2, since a secondary ion mass spectrometry (SIMS), an atomic emission spectroscopy (AES), an energy dispersive X-ray spectroscopy (EDS), a glow discharge mass spectrometry (GD-MS), and the like which are frequently used in measuring a substance distribution need to be performed under high vacuum, it is possible to measure in only a laboratory level and it is impossible to practically apply to a production line. Since an inductively coupled plasma mass spectrometry (ICP-MS) which is widely used other than those mentioned above has difficulty in that a piece to be analyzed needs to be dissolved in a solvent and should then be analyzed, it is also impossible to apply to the production line. Currently, an X-ray fluorescence (XRF), which is widely used for analyzing substance of a solar cell material in the laboratory or in the field due to simplicity of use is relatively inexpensive and may measure under air atmosphere, but has a technical limitation in measuring the substance distribution of a CIGS film in that \textcircled{1} since light elements such as Na, O, N, C, B, Be, Li, and the like are hardly measured, it is impossible to measure a Na content in the CIGS film, which has a decisive effect on a component efficiency, \textcircled{2} the XRF has a precision in a depth direction of at most about 1 μm, it is impossible to measure the element distribution in the depth direction in the CIGS film having a thickness of 2 μm, and \textcircled{3} it is difficult to determine whether a fluorescence signal to be measured is output from a practical film or a substrate.

In general, a semiconductor solar cell refers to a device of directly converting solar light into electricity using a photovoltaic effect in which electrons are generated when irradiating light on a semiconductor diode comprised of a p-n junction. As most basic configuration components, there are three portions such as a front electrode, a back contact electrode, and a light absorbing layer disposed therebetween. Among these, most important material is the light absorbing layer that determines most of photoelectric transformation efficiency, and the solar cell is classified into various kinds according to the above-mentioned material. Particularly, a CIGS film solar cell refers to that in which the material of the light absorbing layer is made of Cu(In, Ga)Se₂ which is a I-III-VI₂ compound. The CIGS film solar cell, which is a high efficiency and low cost type solar cell, has recently been competitively marketed globally, has been prominent as the surest two-generation solar cell replacing a crystalline silicon solar cell in a solar cell field, and represents efficiency closest to a single crystalline silicon component, which is the maximal efficiency of 20.6%.

FIG. 3 is an illustration view schematically showing a structure of the CIGS film solar cell.

FIG. 4 is a flow chart schematically showing a process of manufacturing a CIGS film module.

Firstly, the CIGS film solar cell is manufactured by sequentially depositing a Mo layer, a CIGS layer, a CdS layer, and a TCO layer on a substrate. A detailed description thereof is as follows. The CIGS film module is manufactured by firstly depositing Mo, which is a back contact electrode layer on the substrate, forming (P1 scribing) a pattern by a scribing process, sequentially depositing the CIGS layer and a CdS buffer layer, which are the absorbing layers on the Mo layer having the pattern formed thereon, forming (P2 scribing) a pattern by the scribing process, then sequentially depositing a transparent conductive oxide layer and a front electrode grid made of Ni/Al on the CdS layer, and finally forming (P3 scribing) a pattern by performing the scribing process. The scribing process as described above is a process performing the patterning so as to be connected in series at a constant interval in order to prevent a decrease in efficiency due to an increase in a sheet resistance while an area of the solar cell is increased, and is performed over a total of three times, that is, P1, P2, and P3. According to the related art, the P1 scribing process performs the patterning using a laser, and the P2 and P3 scribing processes perform the patterning using a mechanical method, but a technology in which all of the P1, P2, and P3 scribing processes perform the patterning using the laser has been recently developed.

In a case of the CIGS film solar cell as described above, it has been reported that a thickness (1 to 2.2 μm), a structure of the device, a composition of substance configuring the CIGS film which is a multinary compound, and an element distribution in the film have a decisive effect on light absorption and photoelectric transformation efficiency, that sodium (Na) diffused into a CIGS light absorbing layer from soda-lime glass which is widely used as the substrate during the process increases a charge concentration of the film (Nakada et al., Jpn. J. Appl. Phys., 36, 732 (1997)) or increases a CIGS single grain size to thereby decrease structural characteristic variation according to a composition change and improve photoelectric transformation efficiency (Rockett et al., Thin Solid Films 361-362 (2000), 330; Probst et al., Proc of the First World Conf. on Photovoltaic Energy, Conversion (IEEE, New York, 1994), p144). The reports as mentioned above show that chemical characteristics of the light absorbing layer need to be controlled by measuring the substance distribution in the film in order to manage quality in the production line of the CIGS film solar cell.

Meanwhile, a continuous production process of the CIGS film solar cell is mainly classified into a roll-to-plate (hereinafter, referred to as R2P) process using a hard material substrate such as the soda-lime glass and a roll-to-roll (hereinafter, referred to as R2R) process using a soft material substrate such as a metal thin plate such as stainless steel, Ti, Mo, or Cu, a polymer film such as polyimide, or the like. At a current time in which the present application is filed, a line of the continuous production process is not provided with a system capable measuring physical and chemical characteristics of the CIGS film having the decisive effect on performance of the product in real time, such that physical and chemical characteristics as mentioned above cannot but depend on values which are pre-determined in a research and development phase. In addition, even though the physical and chemical characteristics are deviated from a physical and chemical standard targeted by a practical production process, it is impossible to separately check, and the deviated physical and chemical characteristics cannot but be found through degradation in performance and quality in a phase of evaluating the final completed product, thereby causing significant loss of the product. The continuous production process as described above requires considerable effort and time in order to detect a physical and chemical variable causing the degradation in performance and quality of the product, thereby causing an increase in price and degradation in competitiveness. Therefore, a development of a process control system capable of measuring physical and chemical characteristics of the CIGS film formed in real time without the pre-conditioning process in the continuous production process line has been urgently demanded.

### SUMMARY OF THE INVENTION

An object of the present invention is to provide a component quantitative analyzing method depending on a depth of a CIGS film selecting spectral lines having similar characteristics among the spectra of a specific element and using a value summing intensities of the selected spectral lines.

Another object of the present invention is to provide a method of measuring a component ratio of a first element and a second element by selecting spectral lines having similar characteristics among spectra of the first element and the second element and using a value summing intensities of the respective spectral lines.

According to an exemplary embodiment of the present invention, there is provided a component quantitative analyzing method depending on a depth of a CIGS film, the method including: generating plasma by irradiating a laser beam on the CIGS film and obtaining spectra generated from the plasma, selecting a spectral line or spectral lines having similar characteristics among spectra of specific elements of the CIGS film, and measuring component composition using a value obtained by summing intensities of the selected spectral lines.

The selection of spectral lines having similar characteristics may include selecting spectral lines having the same or similar upper energy level.

The intensities of the selected spectral lines may have a linear correlation.

The measuring of the component composition may include plotting a sum of the intensities of the selected spectral lines and the depth of the CIGS film.

The method may further include converting the number of times of irradiating the laser beam into the depth of the CIGS film using an ablation rate of the laser beam.

According to another exemplary embodiment of the present invention, there is provided a component quantitative analyzing method depending on a depth of a CIGS film, the method including: generating plasma by irradiating a laser beam on the CIGS film and obtaining spectra generated from the plasma, selecting spectral lines having similar characteristics among the spectra of a first element of the CIGS film, selecting spectral lines having similar characteristics among the spectra of a second element of the CIGS film, and measuring component ratio of the first element and the second element using a value obtained by summing intensities of the spectral lines of the first element and a value obtained by summing intensities of the spectral lines of the second element.

The selection of spectral lines of the first element and the selection of spectral lines of the second element may include selecting spectral lines having a similar upper energy level.

The intensities of the spectral lines of the first element may have a linear correlation, and the intensities of the spectral lines of the second element may have a linear correlation.

The measuring of the component composition may include plotting a value obtained by dividing a sum of intensities of the spectral lines of the first element by a sum of intensities of the spectral lines of the second element, and the depth of the CIGS film.

The method may further include converting the number of times of irradiating the laser beam into the depth of the CIGS film using an ablation rate of the laser beam.

### BRIEF DESCRIPTION OF THE DRAWINGS

FIG. 1 is an illustration view showing an operation principle of an LIBS according to the related art;

FIG. 2 is a chart comparing the LIBS with other measuring technologies;

FIG. 3 is an illustration view schematically showing a structure of the CIGS film solar cell;

FIG. 4 is a flow chart schematically showing a process of manufacturing a CIGS film module;

FIG. 5 is a diagram showing a cross-sectional shape of an ablation crater according to the number of pulses;

FIG. 6 is a scanning electron microscope (SEM) photograph photographing a surface of the ablation crater of FIG. 5;

FIG. 7 is an LIBS spectrum of the CIGS film having a wavelength range of 375 nm to 470 nm;

FIG. 8 is an LIBS spectrum of the CIGS film having a wavelength range of 500 nm to 600 nm;

FIG. 9 is a graph each showing a linear correlation between spectral line intensities of Ga and In;

FIG. 10 is a diagram for describing a method of measuring the spectral line intensity used in the LIBS;

FIGS. 11 and 12 are graphs showing results measuring the spectral line intensities of elements according to a depth of the CIGS film using a method according to a first exemplary embodiment of the present invention;

FIG. 13 is a graph showing SIMS intensity depending on the depth of the CIGS film measured using an SIMS which is a measuring method according to the related art;

FIG. 14 is a calibration curve derived by plotting the LIBS spectral line intensity of Na and a concentration of Na measured by the SIMS;

FIG. 15 is a graph showing a concentration profile of Na depending on the depth of the CIGS film; and

FIG. 16 is a graph together showing a result obtained by measuring a component ratio of Ga and In depending on the depth of the CIGS film by a method according to a second exemplary embodiment of the present invention and a result measured by the SIMS.

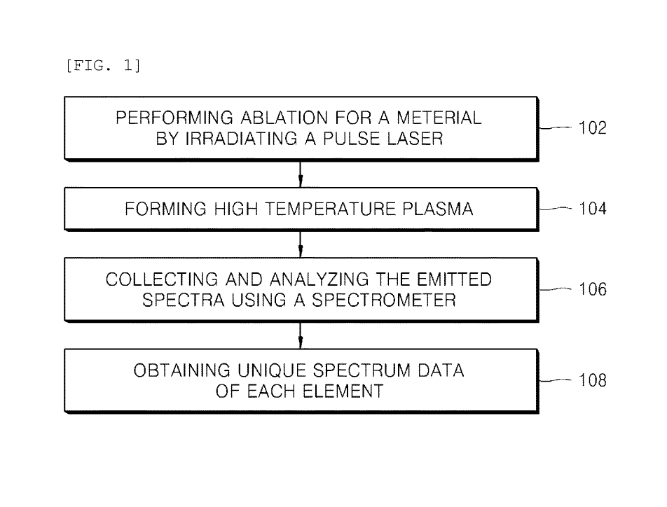

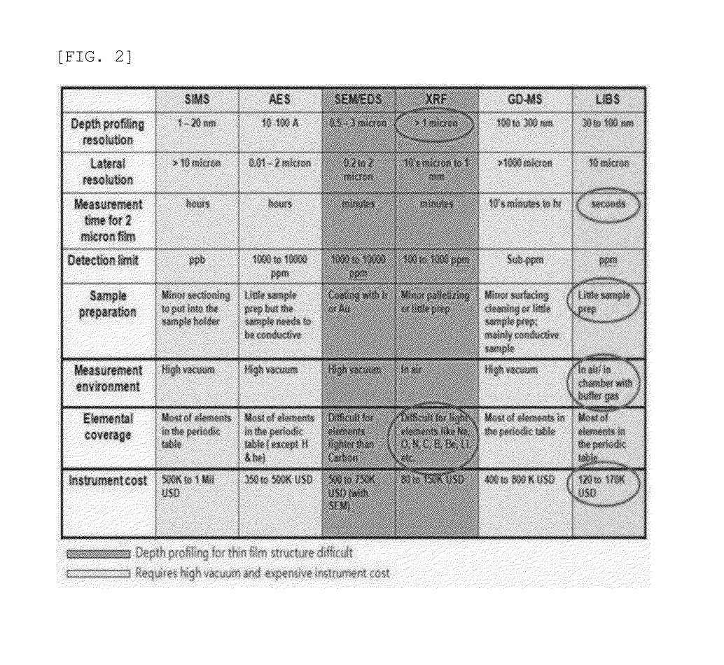

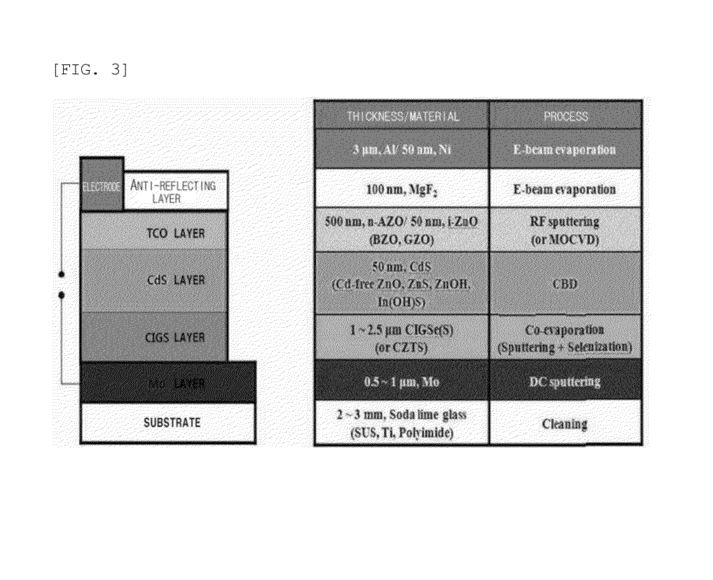

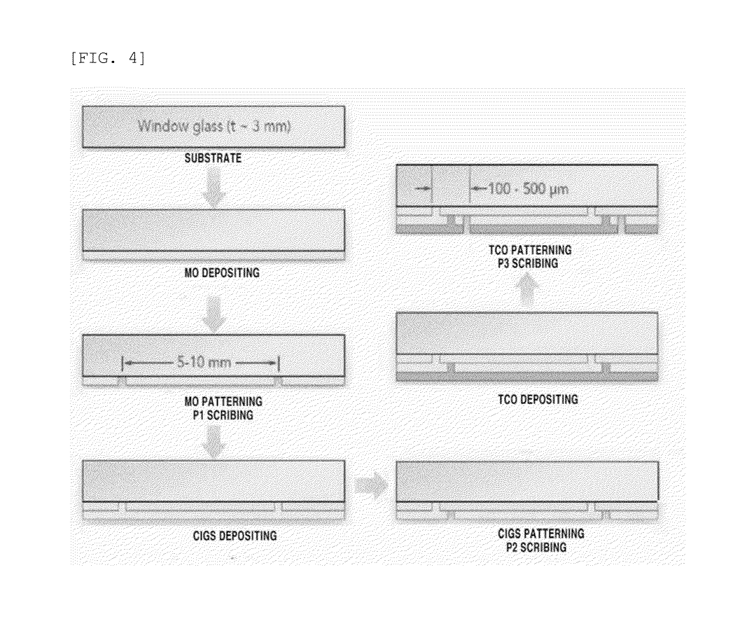

### DESCRIPTION OF THE EXEMPLARY EMBODIMENTS

Hereinafter, exemplary embodiments of the present invention will be described in detail with reference to the accompanying drawings. Like reference numerals designate like components in the description and the accompanying drawings and an overlapped description will be omitted. In addition, if it is determined that the detail description of relevant known functions or components makes subject matters of the present invention obscure, the detailed description thereof will be omitted.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Unless explicitly described to the contrary, a singular form may include a plural form in the present specification. The word “comprises” or “comprising,” will be understood to imply the inclusion of stated constituents, steps, operations and/or elements but not the exclusion of any other constituents, steps, operations and/or elements.

A component quantitative analyzing method depending on a depth of a CIGS film according to a first exemplary embodiment of the present invention may include generating plasma by irradiating a laser beam on the CIGS film and obtaining spectra generated from the plasma, selecting spectral lines having similar characteristics among spectra of specific elements of the CIGS film, and measuring component composition using a value obtained by summing intensities of the selected spectral lines.

Generating plasma by irradiating a laser beam on a CIGS film and Obtaining spectra from the plasma

It is known that the CIGS film has a band gap of 1 eV to 1.7 eV (729.32 nm to 1239 nm) depending on a component composition. Optical transmittance is sharply increased in an infrared region, such that the entire CIGS film may be damaged. Therefore, a laser having a wavelength of 729 nm or less needs to be used in order to measure a composition change for each depth.

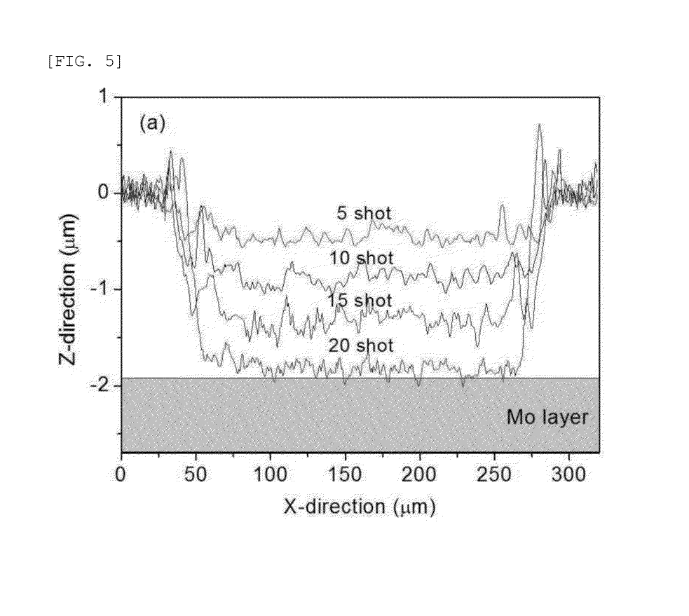

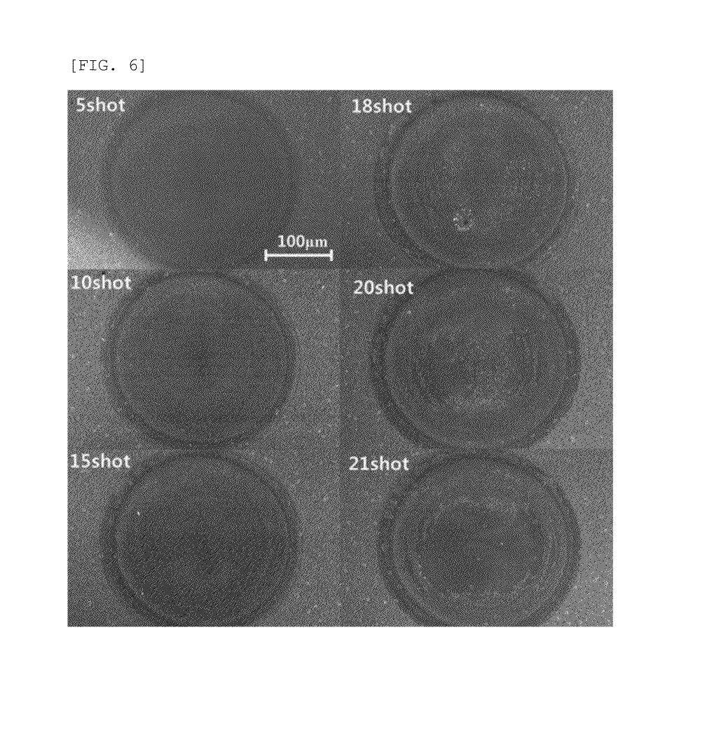

In the present exemplary embodiment, an ablation crater was formed in the CIGS film while increasing the number of pulses using a laser having a wavelength of 532 nm. FIG. 5 is a diagram showing a cross-sectional shape of an ablation crater according to the number of pulses and FIG. 6 is a scanning electron microscope (SEM) photograph photographing a surface of the ablation crater.

Meanwhile, the spectrum components obtained from the plasma are shown as spectra by a spectrum detecting optical unit, or the like.

Selecting Spectral Lines Having Similar Characteristics Among Spectra of Specific Elements of the CIGS Film

Table 1 is a chart showing spectral line characteristics of Ga, In, Cu, and Na which are main configuration elements of the CIGS film.

TABLE 1

| Number | Atomic Symbol | λᵢⱼ(nm) | E_{lower}-Eᵤₚₚₑᵣ (eV) |
|---|---|---|---|
| 1 | Ga(I) | 287.424 | 0.0000-4.3124 |
| 2 | Ga(I) | 294.364 | 0.1024-4.3131 |
| 3 | Ga(I) | 403.299 | 0.0000-3.0734 |
| 4 | Ga(I) | 417.204 | 0.1024-3.0734 |
| 5 | In (I) | 303.935 | 0.0000-4.0781 |
| 6 | In (I) | 325.608 | 0.2743-4.0810 |
| 7 | In (I) | 410.175 | 0.0000-3.0218 |
| 8 | In (I) | 451.130 | 0.2743-3.0218 |
| 9 | Cu (I) | 510.554 | 1.3889-3.8167 |
| 10 | Na (I) | 588.995 | 0.0000-2.1044 |
| 11 | Na (I) | 588.592 | 0.0000-2.1023 |

(λᵢⱼ is a wavelength of a spectral line, E_{lower} is a lower energy level of the spectral line, and Eᵤₚₚₑᵣ is an upper energy level of the spectral line)

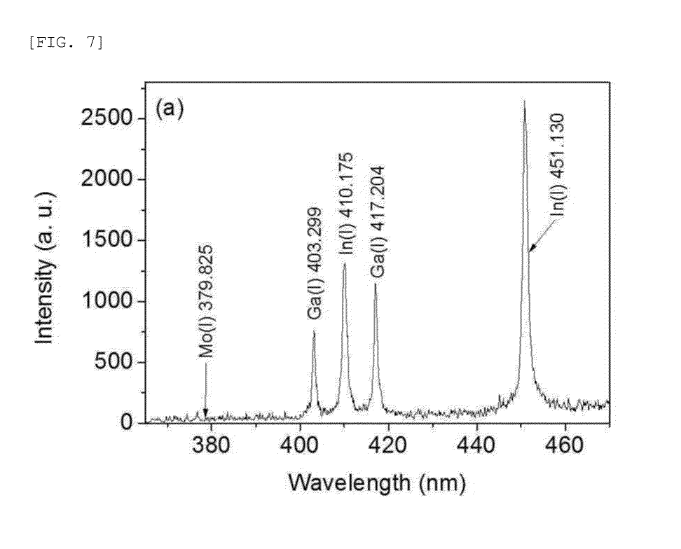

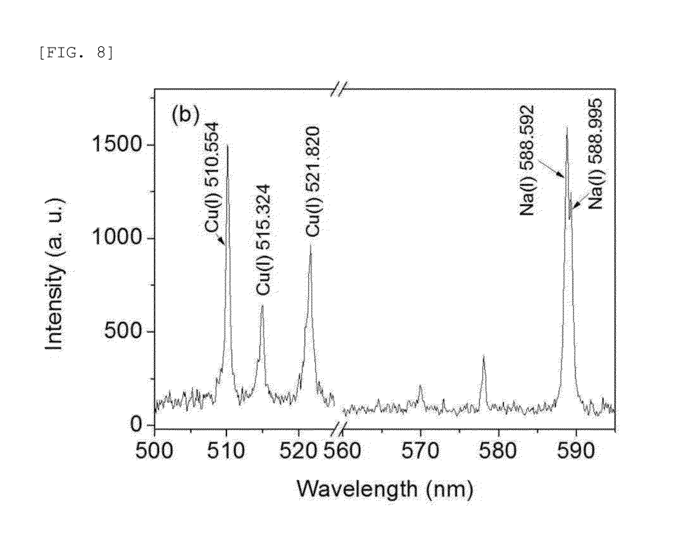

FIG. 7 is an LIBS spectral line of the CIGS film having a wavelength region of 375 nm to 470 nm and FIG. 8 is an LIBS spectrum of the CIGS film having a wavelength region of 500 nm to 600 nm.

However, in the case in which the upper energy levels of the spectral lines of any element are the same as each other or similar to each other, a linear correlation between intensities of the spectral lines is established.

For example, referring to Table 1, in a case of In, the upper energy level of the spectral line at 410.175 nm wavelength and the upper energy level of the spectral line at 451.130 nm wavelength are equal to 3.0218 eV. In this case, the intensities of these In spectral lines have a linear correlation as the following Equation 1.

I_{In(I)451.130}=2.497×I_{In(I)410.175} (1)

(I_{In(I)451.130} is spectral intensity of the In line at 451.130 nm wavelength, and I_{In (I)410.175} is spectral intensity of the In line at 410.175 nm wavelength)

In addition, in a case of Ga, the upper energy level of the spectral line at 417.204 nm wavelength and the upper energy level of the spectral line at 403.299 nm wavelength are equal to 3.0734 eV, and the intensities of these Ga spectral lines have a linear correlation as the following Equation 2.

I_{Ga(I)417.204}=0.543×I_{Ga(I)403.299} (2)

(I_{Ga(I)417.204} is the spectral intensity of the Ga line at 417.204 nm wavelength, and I_{Ga(I)403.299} is the spectral intensity of the Ga line at 403.299 nm wavelength)

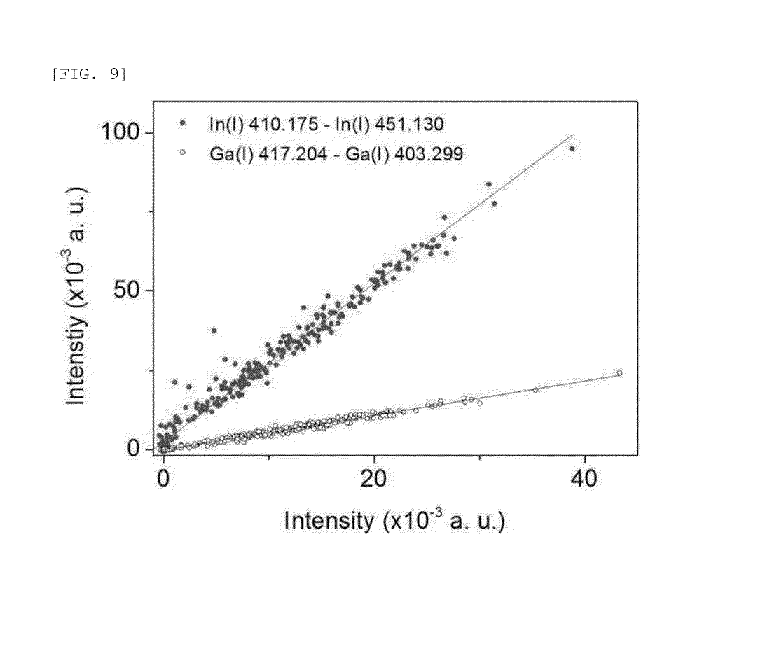

The above equations 1 and 2 are based on FIG. 9. FIG. 9 shows results obtained by irradiating a laser beam on the CIGS film 300 times (continuously irradiating 10 spots on the surface 30 times each). An X axis of FIG. 9 indicates the spectral intensity of the Ga line at 403.299 nm wavelength or the spectral intensity of the In line at 410.175 nm wavelength, and a Y axis indicates the spectral intensity of Ga line at 417.204 nm wavelength or the spectral intensity of In line at 451.130 nm wavelength.

As described above, there is a linear correlation between the intensities of the spectral lines having the same or similar upper energy level among the spectral lines of the specific elements of the CIGS film. Therefore, the intensities of the spectral lines of an element having the above-mentioned linear correlation may be summed so as to be used for a component quantitative analysis.

In the case of Ga, In, and Na shown in Table 1, combinations in which the intensities of the spectral lines have the linear correlation are enumerated as follows.

Ga: 287.424 nm+294.364 nm; 403.298 nm+417.204 nm

In: 303.935 nm+325.608 nm; 410.175 nm+451.130 nm

Na: 588.995 nm+588.592 nm

Measuring Component Composition Using a Value Obtained by Summing Intensities of the Selected Spectral Lines

In LIBS, a value obtained by integrating the area under the peak bounded by a line connecting two points in the tail of the peak at both sides is used as the intensity of the spectral line.

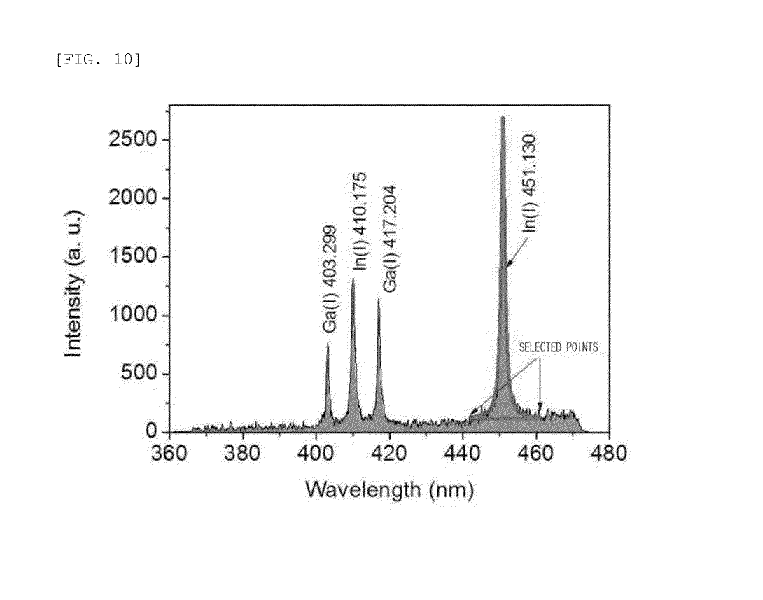

For example, a value obtained by integrating a portion surrounded by a red line in FIG. 10 is the spectral intensity of the In line at 451.130 nm wavelength. Meanwhile, in the case in which an intensity of a normalized spectral line needs to be used, a value obtained by dividing the intensity of the spectrum calculated above by a value obtained by integrating the entire wavelength region (a gray portion of FIG. 10) is used. In this case, deviation of a signal at the time of the measurement may be decreased.

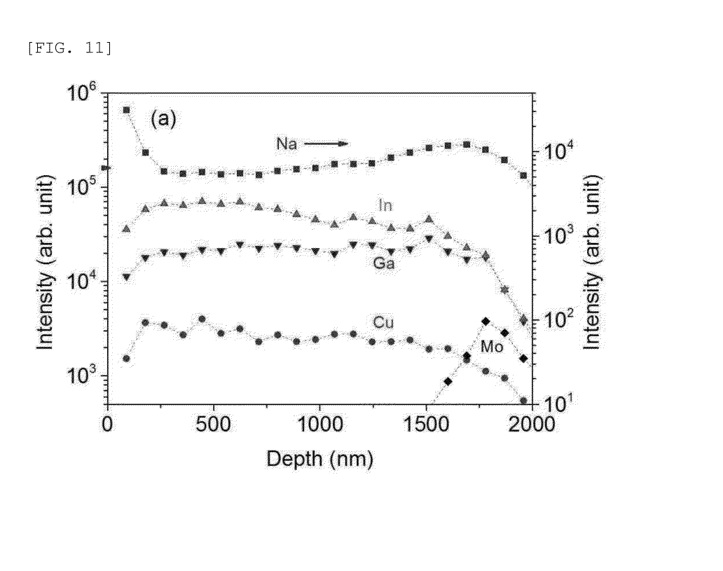

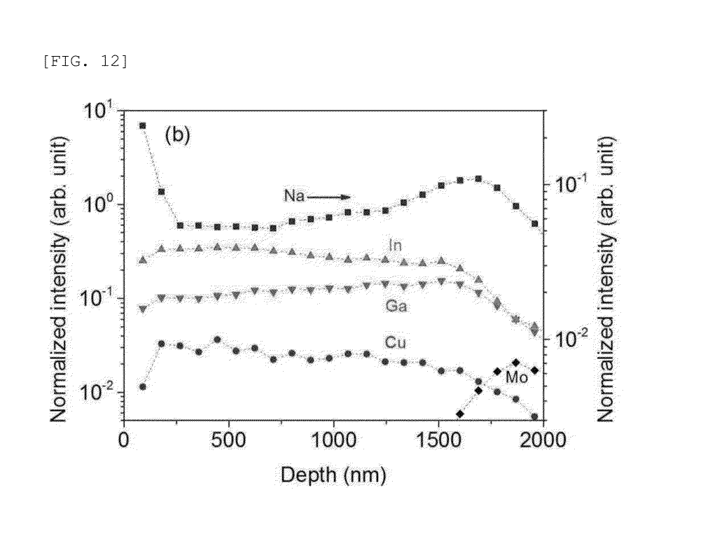

The results obtained by measuring the spectral line intensities of the elements depending on a depth of the CIGS film using the above described method are as in FIGS. 11 and 12.

In FIGS. 11 and 12, an X axis indicates an ablated depth of the CIGS film. By setting an ablation rate to 88.7 nm per pulse, the number of times being irradiated by the laser has been converted into the ablated depth. In FIG. 12, a Y axis indicates a normalized intensity of each spectral line.

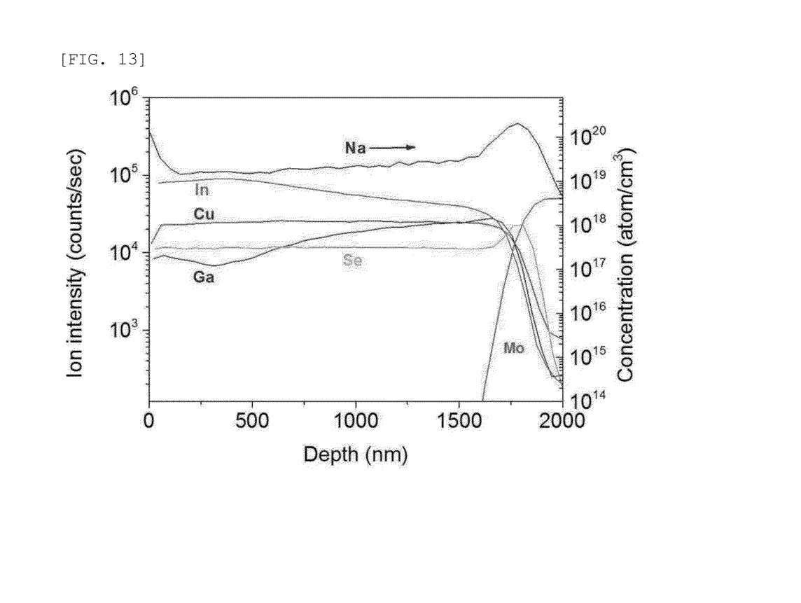

Meanwhile, FIG. 13 is a graph showing SIMS intensity depending on the depth of the CIGS film measured using a SIMS which is a measuring method according to the related art.

Comparing FIGS. 11 and 12 with FIG. 13, it may be appreciated that an intensity profile of the spectral line of the element depending on the depth of the CIGS film according to the present exemplary embodiment is similar to a SIMS intensity profile.

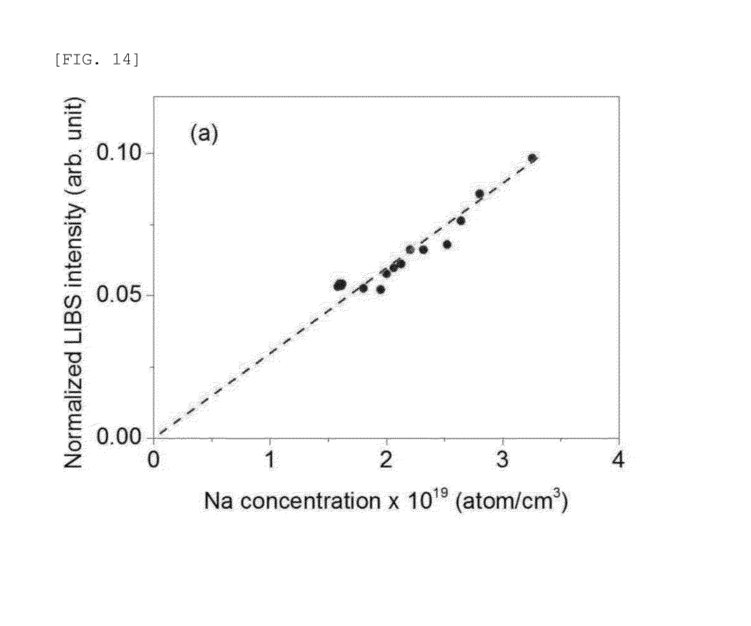

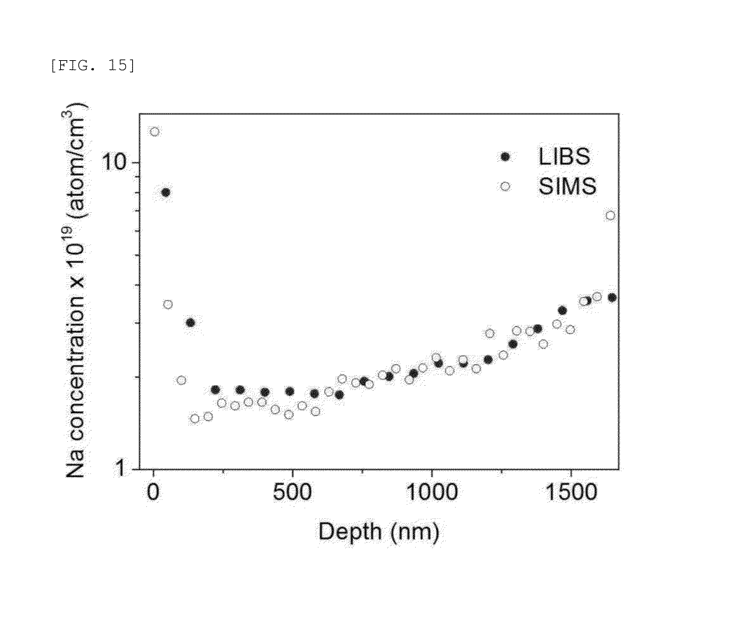

FIG. 14 is a calibration curve derived by plotting the LIBS spectral line intensity of Na and a concentration of Na measured by the SIMS, and FIG. 15 is a graph showing a concentration profile of Na depending on the depth of the CIGS film.

As shown in FIG. 14, since there is a linear correlation between the LIBS spectral line intensity of Na and the concentration of Na measured by the SIMS, plotting a concentration profile of Na depending on the depth of the CIGS using a linear fitting is as FIG. 15. As shown in FIG. 15, the concentration profiles of Na depending on the LIBS and SIMS were similarly expressed.

As described above, the component depending on the depth of the CIGS is quantitatively analyzed using the intensity profile of the spectral line according to the first exemplary embodiment of the present invention, such that a reliable result may be obtained.

A component quantitative analyzing method depending on a depth of a CIGS film according to a second exemplary embodiment of the present invention may include generating plasma by irradiating a laser beam on the CIGS film and obtaining spectral lines generated from the plasma, selecting spectral lines having similar characteristics among spectra of the first element of the CIGS film, selecting spectral lines having similar characteristics among spectra of the second element of the CIGS film, and measuring component ratio of the first element and the second element using a value obtained by summing intensities of the spectral lines having similar characteristics of the first element and a value obtained by summing intensities of spectral lines having similar characteristics of the second element.

Hereinafter, a description of portions overlapped with the first exemplary embodiment among configurations of the second exemplary embodiment will be omitted, and a difference therebetween will be mainly described.

Selecting Spectral Lines Having Similar Characteristics Among Spectra of the First Element of the CIGS Film and Selecting Spectral Lines Having Similar Characteristics Among Spectra of the Second Element of the CIGS Film

In the case in which a component ratio is to be measured, a combination in which the intensities of the spectral lines having linear correlation is obtained in Ga and In, respectively. Referring to Table 1, possible combinations are as follow.

Ga: 287.424 nm+294.364 nm and In: 303.935 nm+325.608 nm

Ga: 403.298 nm+417.204 nm and In: 410.175 nm+451.130 nm

Measuring Component Ratio of the First Element and the Second Element Using a Value Obtained by Summing Intensities of the Spectral Lines Having Similar Characteristics of the First Element and a Value Obtained by Summing Intensities of the spectral lines having similar characteristics of the Second Element

A component ratio of Ga and In depending on the depth of the CIGS film was measured using a value obtained by summing the intensities of the spectral lines in the respective combinations obtained above and dividing the spectral line intensity of Ga combination by the spectral line intensity of In combination, that is, an intensity ratio of the spectral lines.

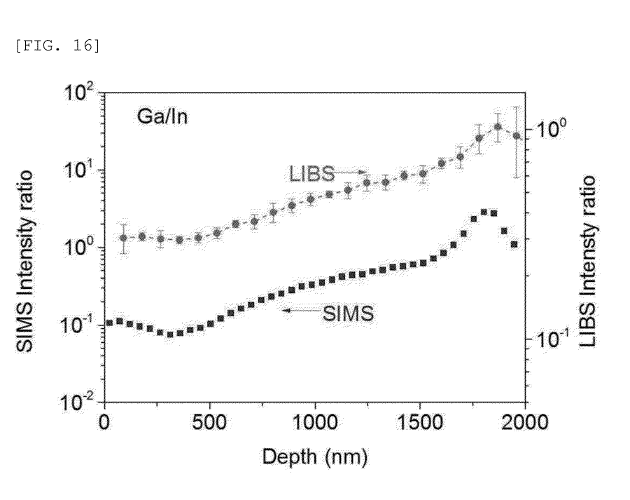

FIG. 16 is a graph together showing a result obtained by measuring a component ratio of Ga and In depending on the depth of the CIGS film by a method according to the present exemplary embodiment and a result measured by the SIMS.

As shown in FIG. 16, it may be appreciated that a profile of an LIBS intensity ratio of the spectral line of Ga and In according to the present exemplary embodiment is similar to a profile of an SIMS intensity ratio. That is, the component ratio of the CIGS film is measured using the method according to the second exemplary embodiment of the present invention, such that the reliable result may be obtained.

According to the exemplary embodiment of the present invention, the component quantitative analyzing method depending on the depth of the CIGS film may perform the component quantitative analysis depending on the depth of the CIGS film by selecting the spectral lines having similar characteristics among the spectra of the specific element and using the value summing the intensities of the selected spectral lines.

In addition, according to another exemplary embodiment of the present invention, the component quantitative analyzing method depending on the depth of the CIGS film may measure the component ratio of any two elements according to the depth of the CIGS film.

The spirit of the present invention has been just exemplified. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirit within a scope equivalent thereto are included in the appended claims of the present invention.

What is claimed is:

1. A component quantitative analyzing method depending on a depth of a CIGS film, the method comprising:
generating plasma by irradiating a laser beam on the CIGS film and obtaining spectra generated from the plasma,
selecting spectral lines having similar characteristics among spectra of specific elements of the CIGS film, and
measuring component composition using a value obtained by summing intensities of the selected spectral lines.

2. The method of claim 1, wherein the selection of the spectral lines includes selecting spectral lines having the same or similar upper energy level.

3. The method of claim 2, wherein the intensities of the selected spectral lines have a linear correlation.

4. The method of claim 3, wherein the measuring of the component composition includes plotting a sum of the intensities of the selected spectral lines and the depth of the CIGS film.

5. The method of claim 4, further comprising converting the number of times of irradiating the laser beam into the depth of the CIGS film using an ablation rate of the laser beam.

6. A component quantitative analyzing method depending on a depth of a CIGS film, the method comprising:
generating plasma by irradiating a laser beam on the CIGS film and obtaining spectra generated from the plasma,
selecting first spectral lines having similar characteristics among spectra of a first element of the CIGS film,
selecting second spectral lines having similar characteristics among spectra of a second element of the CIGS film, and
measuring component ratio of the first element and the second element using a value obtained by summing intensities of the spectral lines having similar characteristics of the first element and a value obtained by summing intensities of the spectral lines having similar characteristics of the second element.

7. The method of claim 6, wherein the selection of the spectral lines having similar characteristics of the first element and the selection of the spectral lines having similar characteristics of the second element include selecting spectral lines having a similar upper energy level.

8. The method of claim 7, wherein the intensities of the spectral lines having similar characteristics of the first element have a linear correlation, and
the intensities of the spectral lines having similar characteristics of the second element have a linear correlation.

9. The method of claim 8, wherein the measuring of the component composition includes plotting a value obtained by dividing a sum of the intensities of the spectral lines having similar characteristics of the first element by a sum of the intensities of the spectral lines having similar characteristics of the second element, and the depth of the CIGS film.

10. The method of claim 9, further comprising converting the number of times of irradiating the laser beam into the depth of the CIGS film using an ablation rate of the laser beam.
